(19) United States
(12) Patent Application Publication
(10) Pub. No.: US 2015/0098184 A1
(43) Pub. Date: Apr. 9, 2015

(54) DOCK STATION WITH MOVABLE SUPPORT

(71) Applicant: MOPHIE, INC., Tustin, CA (US)

(72) Inventors: DENNY TSAI, TEMPLE CITY, CA (US); WALTER SINGHON TAM, IRVINE, CA (US)

(21) Appl. No.: 14/509,931

(22) Filed: Oct. 8, 2014

Related U.S. Application Data
(60) Provisional application No. 61/888,921, filed on Oct. 9, 2013.

(51) Int. Cl. G06F 1/16

(52) U.S. Cl. CPC G06F 1/1632
USPC 361/679.56

(57) ABSTRACT

Disclosed is a dock station that can form an electrical connection with a portable electronic device. The dock station can form the electrical connection with the portable electronic device when the portable device is being used with a protective case. The dock station can have a movable support to accommodate various thickness of the protective case while still allowing for a connector of the dock station to form an electrical connection with a communication port of the portable electronic device.

### CROSS-REFERENCE TO RELATED APPLICATIONS

This application claims the benefit under 35 U.S.C. §119(e) of U.S. Provisional Patent Application No. 61/888,921, titled “DOCK STATION WITH MOVABLE BASE,” and filed on Oct. 9, 2013, which is incorporated herein by reference and made a part of this specification.

### BACKGROUND

1. Field

This application generally relates to appliance or electrical device connectors, particularly to dock stations for portable electronic devices.

2. Description of the Related Art

Many mobile/portable devices (e.g., mobile phones, digital assistants, mobile communication devices, handheld video game devices, handheld computing devices, table computers, personal music/video/content players, navigation systems, sensors, and storage devices) may be expensive, may have fragile equipment such as breakable glass touchscreens and lenses, may have easily scuffed decorative finishes, may have delicate internal electronic components, and may have easily broken or lost buttons and/or switches. People have also become more and more dependent on the data, contacts, and calendars stored in their mobile devices, even as the devices shrink and incorporate more expensive and more sensitive components. These expensive devices and the critical stored data can be protected with a relatively inexpensive protective case. Stated differently, the portable electronic devices can be used with protective cases to help prevent damage to the portable electronic device. Appliance or electrical device connectors and dock stations can be used to connect to portable devices for charging, syncing, and/or other electrical connections.

### SUMMARY

When portable electronic devices with protective cases are connected to connectors and/or dock stations, some protective cases can interfere with full engagement and electrical connection with the connectors and/or dock stations. The protective cases can add extra thickness and/or bulk to portable electronic device that some connectors and/or dock stations may not be designed to accommodate when forming an electrical connection with the portable electronic device. Disclosed herein are various embodiments of connectors and/or dock stations designed to accommodate protective cases that may be positioned on or over the portable electronic device while providing a sufficient electrical communication between the electrical connector and an electrical communication port of the portable electronic device.

Various embodiments of this disclosure relate to a dock station for use with a portable electronic device. The dock station can include the following: a base; a connector extending generally upward from the base, the connector configured to engage a connection port on a portable electronic device to provide an electrical connection between the dock station and the portable electronic device movable platform that is movable relative to the connector, the movable platform movable between a raised position and a lowered position, and the movable platform configured to support a bottom of the portable electronic device; and a biasing element that biases the movable platform toward the raised position.

In some embodiments, the dock station can include one or more of the following: the movable platform includes an opening; the connector extends through the opening in the movable platform; the connector is movable between a forward position and a rearward position; a connector biasing element that biases the connector toward the forward position; the connector biasing element includes a spring; the connector includes one or more cams; rotation of the cam as the connector moves toward the rearward position causes the one or more cams to displace the connector biasing element to produce a force that urges the connector toward the forward position; the connector is pivotable between the forward position and the rearward position; a back support rearward of the connector, the back support configured to support a back of the portable electronic device; a leveling mechanism that maintains the movable platform substantially level as the movable platform moves between the raised position and the lowered position; the leveling mechanism includes an axle configured to rotate about a longitudinal axis of the axle, two or more gears coupled to the axle such that the two or more gears rotate with the axle, the two or more gears spaced apart from each other, two or more tracks configured to engage the respective two or more gears, and the engagement between the two or more gears and the respective two or more tracks is configured to maintain the movable platform substantially level as the movable platform moves between the raised position and the lowered position; the biasing element biases the two or more gears to rotate in a predetermined direction such that the tracks are moved to position the movable platform in the raised position; the axle is coupled to the base; the two or more tracks are coupled to the movable platform; the biasing element extends along the longitudinal axis of the axle and is coupled to at least one of the axle or the two or more gears; the leveling mechanism includes two or more shafts, two or more sleeves configured to slidably receive the respective two or more shafts, and the engagement of the two or more shafts with the respective two or more sleeves is configured to maintain the movable platform substantially level as the movable platform moves between the raised position and the lowered position; at least four sleeves configured to slidably receive at least four respective shafts; the two or more shafts extend generally upward from the base; the two or more sleeves are coupled to the movable platform; the two or more shafts extend generally downward from the movable platform; the two or more sleeves are coupled to the base; at least one of the two or more shafts or the two or more sleeves contact a stop surface to inhibit movement of the movable platform beyond at least one of the raised position or the lowered position; the leveling mechanism includes a shaft having an outer diameter, a sleeve configured to slidably receive the shaft, the sleeve having a length and an inner diameter, and the outer diameter of the shaft, the inner diameter of the sleeve, and the length of the sleeve are configured to maintain the movable platform substantially level as the movable platform moves between the raised position and the lowered position; the shaft extends generally upward from the base; the sleeve is coupled to the movable platform; the movable platform includes one or more indentations configured to facilitate removal of the portable electronic device from the dock station; one or more ports on the movable platform are positioned to be proximate to at least one of a microphone or a speaker of the portable electronic device when the connector and the connection port are engaged; a range mechanism that limits a travel distance of the movable platform between the raised position and the lowered position; the range mechanism includes a bottom projection connected to the base, a top projection connected to the movable platform, and in the raised position of the movable platform, the bottom projection and the top projection are spaced the travel distance from each other; when the movable platform is moved over the travel distance into the lowered position, the bottom projection and the top projection are in contact with each other to inhibit further movement of the movable platform beyond the lowered position; the movable platform moves between the raised and lowered positions over a travel path of the movable platform; the bottom projection has a longitudinal axis that is aligned with a longitudinal axis of the top portion along the travel path of the movable platform; the biasing element includes a coil spring; the coil spring is positioned around the top and bottom projections; the biasing element is in direct contact with the base and the movable platform; and/or the movable platform moves to the lowered position to accommodate a thickness of a protective case of the portable electronic device to allow the connector to engage the connection port of the portable electronic device.

Various embodiments of this disclosure relate to a dock for use with a portable device. The dock can include the following: a base; an electrical junction connected to the base, the electrical junction configured to engage a connection port on a portable device to provide an electrical connection between the dock and the portable device; and a support surface that is movable relative to the base, the support surface movable between a first position and a second position, and the support surface configured to support a side of the portable device having the connection port.

In some embodiments, the dock can include one or more of the following: a biasing element that biases the support surface toward the first position; the biasing element includes a spring that pushes the support surface into the first position when the support surface is moved from the first position toward the second position such that the spring is compressed; the biasing element is in contact with the base and the support surface; the first position is further away from the base relative to the second position; the support surfaces includes an opening through which the electrical junction connects with the portable device; the electrical junction is movable between a first position of the electrical junction and a second position of the electrical junction; the first position of the electrical junction corresponds to a front of the portable device including a touch screen when the portable device is engaged with the dock; a junction biasing element that biases the electrical junction toward the first position of the electrical junction; the electrical junction connects to one or more flanges; rotation of the flanges as the electrical junction moves toward the second position causes the one or more flanges to displace the junction biasing element to produce a force that urges the electrical junction toward the first position; the electrical junction is pivotable between the first and second positions of the electrical junction; a side support configured to support an other side of the portable device, the other side substantially perpendicular to the side of the portable device supported by the support surface of the dock; the portable device includes a touch screen; the other side is opposite the touch screen on the portable device; a leveling mechanism that maintains the support surface substantially level as the support surface moves between the first position and the second position; the leveling mechanism includes an axle configured to rotate about a longitudinal axis of the axle, two or more gears coupled to the axle such that the two or more gears rotate with the axle; the two or more gears are spaced apart from each other, two or more tracks configured to engage the respective two or more gears, and the engagement between the two or more gears and the respective two or more tracks is configured to maintain the support surface level as the support surface moves between the first position and the second position; the two or more gears are biased to rotate in a predetermined direction such that the tracks are moved to position the support surface in the first position; the axle is coupled to the base; the two or more tracks are coupled to the support surface; the leveling mechanism includes two or more shafts, two or more sleeves configured to slidably receive the respective two or more shafts, and the engagement of the two or more shafts with the respective two or more sleeves is configured to maintain the support surface substantially level as the support surface moves between the first position and the second position; at least four sleeves configured to slidably receive at least four respective shafts; the two or more shafts extend generally from the base; the two or more sleeves are connected to the support surface; the two or more shafts are connected to the support surface; the two or more sleeves are connected to the base; at least one of the two or more shafts or the two or move sleeves contact a stop surface to inhibit movement of the support surface past at least one of the first position or the second position; the support surface is connected to one or more indentations configured to facilitate removal of the portable device from the dock; the support surface is connected to one or more sound ports, the one or more sound ports positioned to be proximate to at least one of a microphone or a speaker of the portable device when the electrical junction and the connection port are engaged; a range mechanism providing a predetermined travel distance of the support surface between the first position and the second position; the range mechanism includes a first protrusion connected to the base, a second protrusion connected to the support surface, and in the first position of the support surface, the first protrusion and the second protrusion are spaced the predetermined travel distance from each other; when the support surface is moved over the predetermined travel distance into the second position, the first protrusion and the second protrusion abut each other to inhibit further movement of the support surface beyond the second position; the support surface moves between the first and second positions over a travel path of the support surface; the first protrusion has a longitudinal axis that is aligned with a longitudinal axis of the second protrusion along the travel path of the support surface; a spring configured to push the support surface into the first position; the spring is positioned around the first and second protrusions; the spring is in direct contact with the base and the support surface; and/or the support surface moves toward the second position to accommodate a thickness of a protective case of the portable device to allow the electrical junction to engage the connection port of the portable device.

Various embodiments of this disclosure relate to a dock for use with a portable device. The dock can include the following: a connector configured to engage the portable device to form an electrical connection between the dock and the portable device; and a support that is movable relative to the connector, the support movable between a first position and a second position, and the support configured to support the portable device.

In some embodiments, the dock can include one or more of the following: a base, the connector pivotally connected to the base and extending from the base toward the support; a biasing element, the biasing element configured to bias the support toward the first position; and/or the support is moved toward the second position when the connector engages the portable device having a protective case disposed on the portable device proximate to a connection port of the portable device configured to engage the connector to form the electrical connection.

The foregoing is a summary and contains simplifications, generalization, and omissions of detail. Those skilled in the art will appreciate that the summary is illustrative only and is not intended to be in any way limiting. Other aspects, features, and advantages of the devices and/or processes and/or other subject matter described herein will become apparent in the teachings set forth herein.

The summary is provided to introduce a selection of concepts in a simplified form that are further described below in the Detailed Description. This summary is not intended to identify key features or essential features of any subject matter described herein.

### BRIEF DESCRIPTION OF THE DRAWINGS

The foregoing and other features of the present disclosure will become more fully apparent from the following description, taken in conjunction with the accompanying drawings. Understanding that these drawings depict only some embodiments in accordance with the disclosure and are, therefore, not to be considered limiting of its scope, the disclosure will be described with additional specificity and detail through use of the accompanying drawings.

FIG. 1 is a side and top view of a portable device with a protective case.

FIG. 2 is a top view of a portable device with a protective case and a connector connected to the portable device.

FIG. 3 is side, top, and perspective view of an embodiment of a dock station.

FIG. 4 is a top view of an embodiment of a dock station.

FIG. 5 is a side view of an embodiment of a dock station.

FIG. 6 is a side, top, and perspective view of a portable device connecting to an embodiment of a dock station.

FIG. 7A is a side view of a portable device without a protective case connecting to an embodiment of a dock station.

FIG. 7B is a side view of a portable device with a protective case connecting to an embodiment of a dock station.

FIG. 8 is a side view showing juxtaposed positions of an embodiment of a movable platform.

FIG. 9 is a side and top view of an embodiment of a dock station.

FIG. 10 is a side and top view of an embodiment of a dock station.

FIG. 11 is a side, top, and perspective view of embodiments of some internal components of an embodiment of a dock station.

FIG. 12 is a side view of embodiments of some internal components of an embodiment of a dock station.

FIG. 13A is a side view of showing a position of an embodiment of a movable platform.

FIG. 13B is a side view of showing another position of an embodiment of a movable platform.

FIG. 14 is a side, top, and perspective view of embodiments of some internal components of an embodiment of a dock station.

FIG. 15 is a back and top view of embodiments of some internal components of an embodiment of a dock station.

FIG. 16 is a front perspective view of some internal components of an embodiment of a dock station.

FIG. 17 is a back perspective view of the internal components of the dock station of FIG. 16, with the movable platform in a raised position.

FIG. 18 is a back perspective view of the internal components of the dock station of FIG. 16, with the movable platform in a lowered position.

FIG. 19 illustrates a cross-sectional side, top, and perspective of an embodiment of a dock.

FIG. 20 illustrates a cross-sectional side, top, and perspective view of an embodiment of some internal components of a dock.

FIG. 21 illustrates a side, top, and perspective view of an embodiment of some internal components of a dock.

### DESCRIPTION

In the following description, reference is made to the accompanying drawings, which form a part hereof. In the drawings, similar symbols typically identify similar components, unless context dictates otherwise. The illustrative embodiments described in the description and drawings are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made a part of this disclosure.

Further, the following description contains, by necessity, simplifications, generalization, and omissions of detail; consequently, those skilled in the art will appreciate that the description is illustrative only and is not intended to be in any way limiting. This description is not intended to identify key features or essential features of any subject matter described herein.

Embodiments disclosed in this application generally relate to appliance or electrical device connectors, particularly to dock stations for portable electronic devices such as mobile phones (e.g., smart phones) or tablet computers.

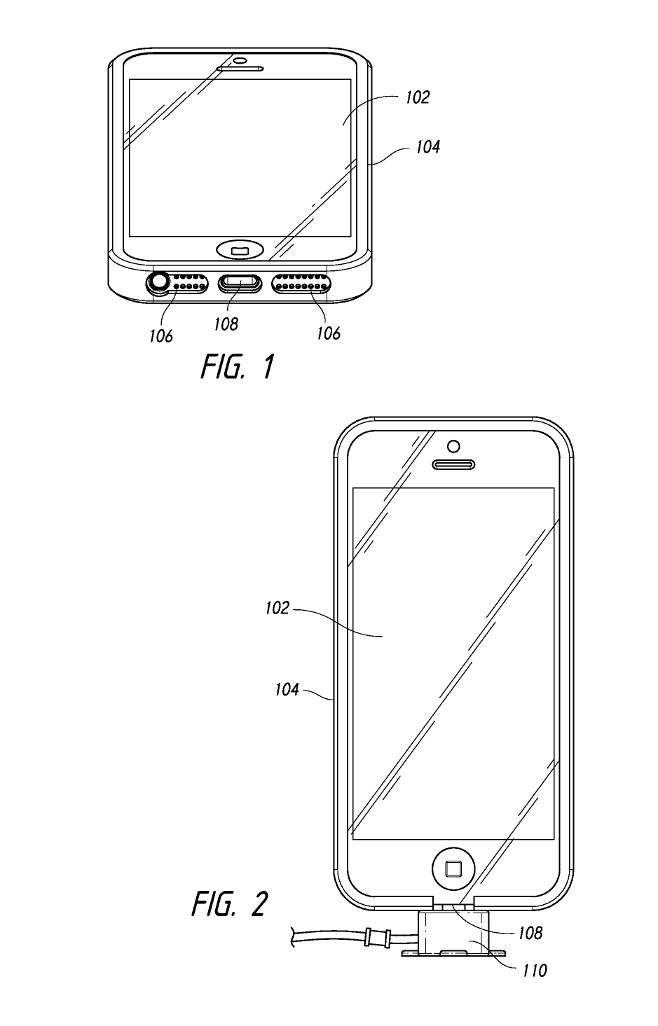

FIG. 1 is a side and top view of a portable electronic device 102 with a protective case 104. The portable electronic device or portable device 102 can be a mobile phone. The mobile phone can have connections and ports for speakers, microphone, (e.g., a speaker/microphone port 106), charging, syncing (e.g., a charging/syncing port 108), and/or the like. The protective case 104 can surround, come in close proximity to, shroud, or enclose any of the ports that the mobile device may have. As shown in FIG. 1, the protective case 104 is in close proximity to at least one connection port (e.g., charging/syncing port 108). The connection port 108 can be a port used for charging, syncing, and/or other electrical connections.

FIG. 2 is a top view of a portable electronic device 102 with a protective case 104 and a cable connector 110 connected to the portable device 102. The cable connector 110 can be used for charging, syncing, and/or other electrical connections with the portable electronic device 102. As shown in FIG. 2, the protective case 104 may obstruct full engagement of the connection port with the cable connector 110. Depending on the thickness of the protective case 104, the connection between the cable connector 110 and connection port 108 can be easily dislodged. The thickness of the protective case 104 at the area adjacent to or near the connection port 108 can also cause a faulty connection between the connection port 108 and the cable connector 110. The protective case 102 can impede the ability of the cable connector 110 to reliably form a connection with the connection port 108 to perform, for example, charging and/or syncing. Depending on the case 104 and the cable connector 110, the protective case 104 may have to be removed to provide a satisfactory connection and/or engagement between the connection port 108 of the portable device 102 and the cable connector 110.

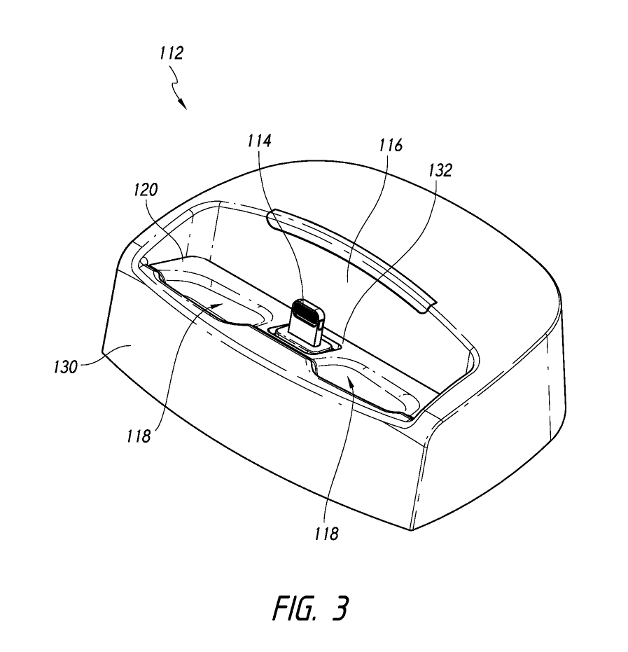

FIG. 3 is side, top, and perspective view of an embodiment of a dock station 112. The dock station 112 may be referred to as simply a dock 112. The dock 112 as discussed further herein can allow the cable connector 110 to connect, mate, and/or engage with the connection port 108 of a portable electronic device 102, such as a mobile phone, to provide a secure connection between the cable connector 110 and the connection port 108 of the portable electronic device 102. The dock 112 can have a dock connector 114 (e.g., a connector, an electrical connection, an electrical junction, etc.) for connecting, mating, and/or engaging with a portable electronic device 102. The dock 112 can support charging, syncing, and/or other electrical connections with the portable electronic device 102 through the connection port 108. The dock 112 can connect, mate, and/or engage with a portable electronic device 102 having a protective case 104 without having to remove the protective case 104. The dock 112 can accommodate protective cases 104 of various thicknesses. The dock 112 can provide sufficient support to the portable electronic device 102 with or without a protective case 104, which can be of various thicknesses.

The connector 114 can be any suitable connector for connecting, mating, and/or engaging the connection port 108 of the portable device 102. For example, the connector 114 can be Apple's Lightning connector, Apple's Thunderbold connector, Apple's 30-pin connector, a universal serial bus (USB) connection (including, for example, Type A, Type B, Mini-A, Mini-B, Micro-A, Micro-B), an AC adapter pin, and/or the like, including proprietary connectors . The connector 114 can be appliance couplers as, for example, set forth in the IEC-60320 standard. The connector 114 can be, for example, C11 and/or C10B connectors.

The dock 112 can have a back support 116 that can support the back or back side/surface of the portable electronic device 102 (e.g., a side opposite the side of the portable electronic device 102 having a touch screen of portable electronic device 102). The back support 116 can be configured to orient the portable electronic device 102 at a desired orientation that facilitates the connection of the connector 114 to the connection port 108 on the portable electronic device 102. For example, the back support 116 can be angled such that when the portable electronic device 102 rests against the back support 116, the portable electronic device 102 is oriented in a position that enables the connector 114 to engage the connection port 108 on the portable electronic device 102. In some embodiments, the back support 116 limits the travel and/or tilting of the connector 114 as discussed herein.

The dock 102 can have speaker and/or microphone ports 118 (e.g., indentations, depressions, cutouts, openings, channels, etc.) for amplifying speaker sound and/or receiving external audio/sound information (e.g., a user talking). The speaker and/or microphone ports 118 can generally be proximate to the speakers of the portable electronic device 102 and reflect sound waves from, for example, downward facing speakers toward (e.g., substantially upward) the user. Relatedly, the speaker and/or microphone ports 118 can generally be proximate to the microphone of the portable electronic device 102 and reflect sound waves into, for example, a downward facing microphone or port of the microphone toward (e.g., substantially upward) the microphone.

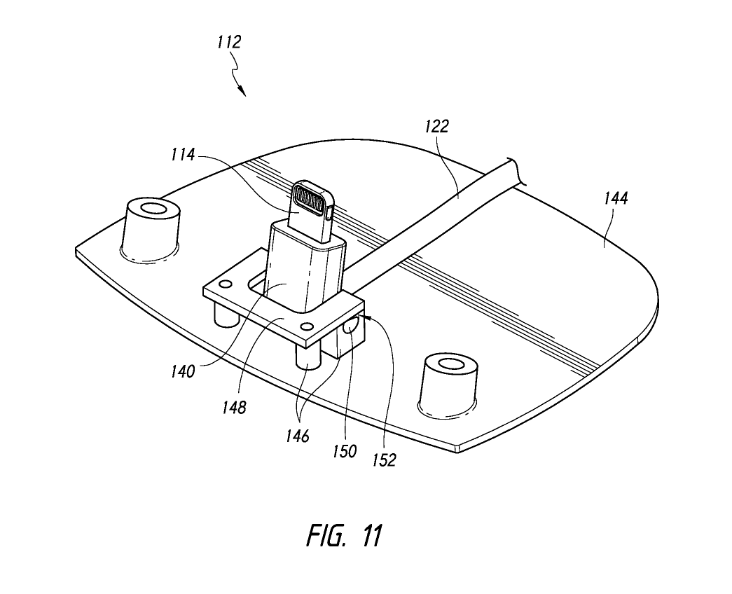

The dock 112 can have a base, support, support surface, or movable platform 120 that automatically adjusts for different thicknesses of the protective case 104 of the portable electronic device 102 while providing sufficient stability to support the portable electronic device 102. The dock 102 can have a USB cable, power cable, and/or any other connecting cable 122 (see FIGS. 11, 12, and 16-18) for charging and/or syncing with the portable device 102 and/or another device, such as, for example, a personal computer as discussed herein. The dock 112 can have a rubber grip on the bottom of housing to keep the dock from sliding. The dock 112 can be weighted for added support and stability. The dock 112 can come in various shapes and colors, such as, for example, black and/or white.

In some embodiments, the dock 112 can comply with certain vendor standards. For example, Apple uses the MFi Program to help ensure that accessories, such as a dock station, meet certain standards for compatibility with the Apple products.

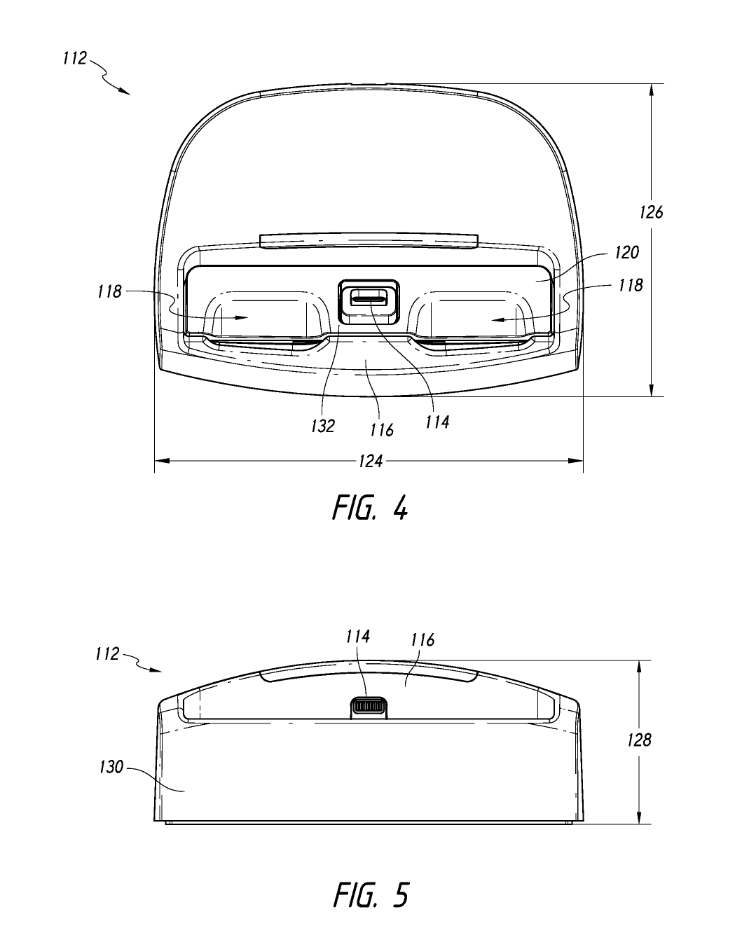

FIG. 4 is a top view of an embodiment of a dock station 112. The dock 112 can have various dimensions. In some embodiments, the width 124 of the dock 112 can range from about 50 mm, or less, to about 150 mm, or more. In some embodiments, the depth 126 of the dock 112 can range from about 20 mm, or less, to about 150 mm, or more, millimeters. FIG. 4 illustrates another view of the connector 114, the back support 116, and the speaker/microphone ports 118 as discussed herein. FIG. 5 is a side view of an embodiment of a dock station 112. In some embodiments, the height 128 of the dock 112 can range from about 10 mm, or less, to about 70 mm, or more. These dimensions are merely examples and do not limit the subject matter disclosed herein. In some embodiments, the dock 112 can be incorporated into, for example, a portable speaker device. As such, the dock 112 may be integrated with the portable speaker device and the dimensions can vary widely depending on the size of the portable speaker device. FIG. 5 illustrates another view of the connector 114 and the back support 116. A front panel 130 of the dock can be lower than the back support 116 such that the connector 114 can be seen when the dock 112 is viewed from the front side.

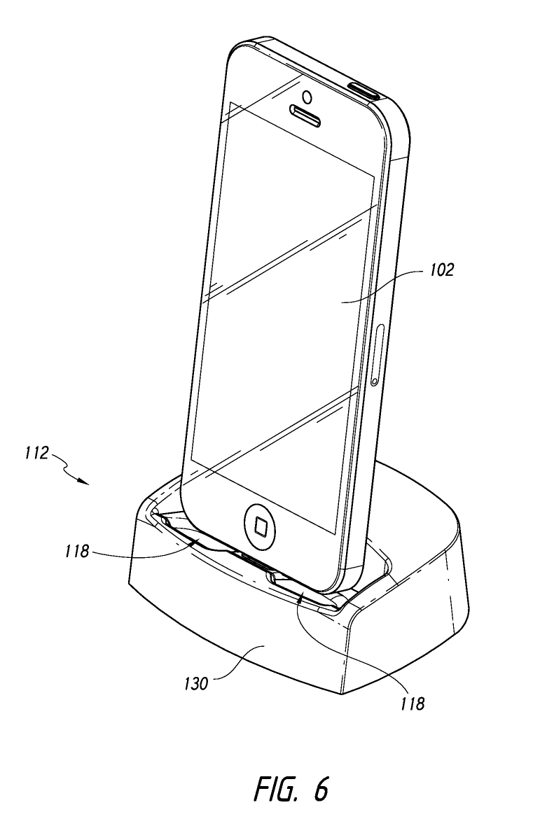

FIG. 6 is a side, top, and perspective view of a portable electronic device 102, such as a mobile phone, connecting to an embodiment of a dock station 112. The dock 112 can engage the portable electronic device 102 with or without a protective case 104. The dock 112 can engage the portable electronic device 102 such that portable electronic device 102 is supported by the dock 112. As illustrated in FIG. 6, the speaker/microphone ports 118 can extend, be shaped, or be formed in the dock 112 beyond a periphery of the phone 102 toward the front panel 130 to provide a channel or an opening around the portable electronic device 102 for sound to travel into and out of the ports 118, toward or away from speakers and/or microphone of the portable electronic device 102. In some embodiments, the dock 112 can engage other portable electronic devices, such as, for example, tablets, e-readers, music players, and/or the like. In some embodiments, the dock 112 can engage multiple types of devices varying in size, dimensions, and connection types as discussed herein.

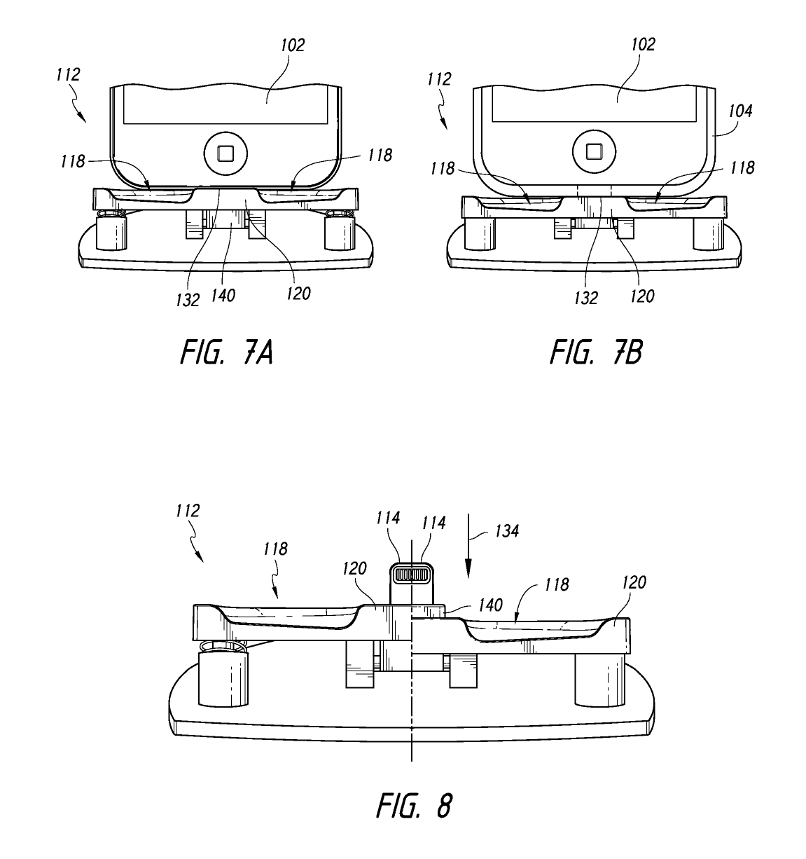

FIG. 7A is a side view of a portable device 102 without a protective case 104 connecting to an embodiment of a dock station 112 without a front panel 130 to illustrate a movable platform 120. The dock 112 can have a movable platform 120 that elevates up to the bottom surface of the portable device 102 body to provide support to the portable device 102 without a protective case 104. The movable platform can have a support surface 132 that contacts, abuts, or engages a bottom surface of the portable device 102 and/or a bottom surface of the protective case 104 to at least vertically support the portable device in a desired or fixed position relative to the movable platform 102 as discussed herein. The support surface 132 can be considered any portion of the movable platform 120 facing or abutting the portable device 102 and providing desired support to the portable device 102 to position the portable device 102 as discussed herein.

FIG. 7B is a side view of a portable device 102 with a protective case 104 connecting to the dock station 112 without a front panel 130 to illustrate the movable platform 120. The movable platform 120 moves down to accommodate the thickness of the protective case 104 while allowing the connector 114 to engage the connection port 108 of the portable device 102. In some embodiments, the movable platform 120 rests against the protective case 104 and provides support that is substantially the same or similar as when connecting to the portable device 102 without a protective case 104. Thus, the movable platform 104 can self adjust to support different case 104 thicknesses. The self adjustment can also maintain a desired clearance between various features of the movable platform 120, such as the speaker/microphone ports 118 and/or other indentations.

FIG. 8 is a side view showing juxtaposed positions of an embodiment of a movable platform 120 (e.g., a dock 112 without a front panel 130 for illustration purposes). The left portion of FIG. 8 shows a position (e.g., a first position) of the movable platform 120 when the portable electronic device 102 without a protective case 104 is engaged with the dock 112 or the movable platform 120 is in a neutral position (without engagement of a portable device 102). The right portion of FIG. 8 shows a position (e.g., a second position) of the movable platform 120 when the portable electronic device 102 with a protective case 104 is engaged with the dock 112. As the right portion of FIG. 8 shows, the movable platform 120 can move down relative to the connector 114 along engagement-direction arrow 134 to accommodate the thickness of the protective case 104. Engagement-direction arrow 134 can correspond to a direction or path (e.g., travel path) along which the portable device 102 can engage with the connector 114 via the connection port 108. Engagement-direction arrow 134 can be substantially vertical. Engagement-direction arrow 134 as illustrated in FIG. 8 can correspond to a downward (e.g., lowered or depressed) direction as discussed herein; whereas, upward (e.g., raised or elevated) direction can be opposite the engagement-direction arrow illustrated in FIG. 8.

In some embodiments, the right portion of FIG. 8 can represent a position (e.g., a second position) of the movable platform 120 when a portable electronic device 102 without a protective case 104 is engaged with the dock 112. The movable platform 120 can move to a different (e.g., lower) position as discussed herein to accommodate various features of the portable device 102 itself. For example, the connection port 108 may be recessed within the body of the portable device 102 such that the movable platform 120 may have to move toward the lowered position to accommodate the body of the portable device 102 (e g , similarly as with a protective case 104 as discussed herein) in order for the connector 114 to sufficiently engage the connection port 108 to form an electrical connection.

As FIG. 8 illustrates, in some embodiments, the connector 114 does not move up and down. The position of the connector 114 can substantially stay the same vertically or along arrow 134, as the movable platform 120 moves from the raised/elevated position (left side of FIG. 8) to the lowered/depressed position (right side of FIG. 8). The movable platform 120 can move down to support a desired thickness of the protective case, such as, for example, a protective case 104 having a thickness of about 0.5 mm, or less, to about 30 mm, or more at the portion of the case 104 that is adjacent or near the connection port 108.

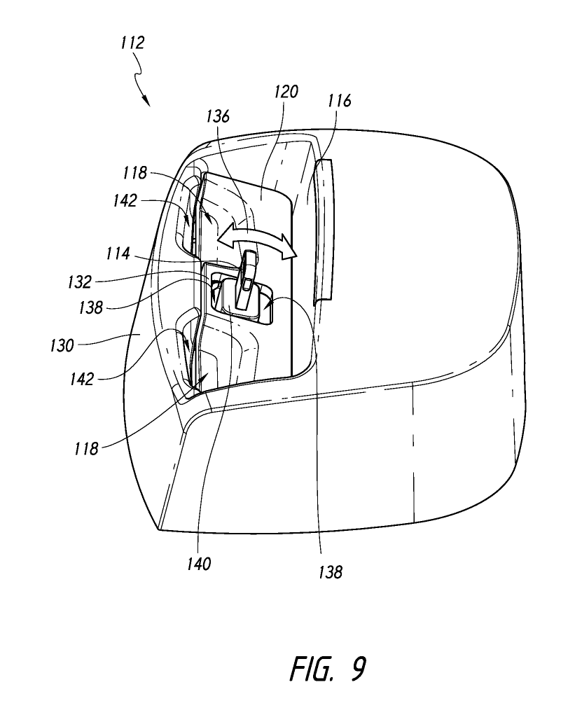

FIG. 9 is a side and top view of an embodiment of a dock station 112. The dock station 112 can have a connector 114 that can move (e.g., pivot or tilt). The movement (e.g., tilting or pivoting) of the connector 114 can be in the backward and forward direction as indicated by a pivoting-direction arrow 136 in FIG. 9. The pivoting-direction arrow 136 can be substantially perpendicular to engagement-direction arrow 134 where, for example, the two arrows 134, 136 conceptually intersect. The movement (e.g., tilting or pivoting) of the connector 114 can be limited by the opening 138 in the dock 112 through which the connector 114 protrudes. For example, the connector 114 can come against or abut a sidewall of the opening 138 to limit the pivoting movement of the connector 114. In some embodiments, the movement (e.g., tilting or pivoting) can be limited by other internal or external features of the dock 112 (e.g., a sidewall of the dock 112) that restrict the degree of tilt of the connector 114. The opening 138 can be formed in the movable platform 120 discussed herein. The degree of movement (e.g., pivoting or tilting) can range from about 5 degrees, or less, to about 40 degrees, or more, and can be at least about 15 degrees. The amount of movement (e.g., pivoting or tilting) can be adjusted to meet various desired configurations. The opening 138 (e.g., in the movable platform 120) can be sized and/or shaped to allow tilting of the connector 114 as discussed herein. The opening 138 (e.g., in the movable platform 120) can be sized and/or shaped to restrict, prevent, and/or inhibit tilting and/or movement of the connector 114 in the left or right direction (direction substantially perpendicular to the direction indicated by the pivoting-direction arrow 136 shown in FIG. 9).

The pivoting or tilting can be supplemented/complimented or replaced by a translational movement of the connector 114. The translational movement can range from an equivalent span of travel when the connector 114 tilts from about 5 degrees, or less, to about 40 degrees, or less. In some embodiments, the translation movement can range from about 1 mm, or less, to about 20 mm, or more. In some embodiments, the connector 114 can move translationally without the connector 114 pivoting or tilting.

The dock 112 can have a back support 116. The back support 116 can be about 5 mm, or less, to about 40 mm, or more, or at least about 15 mm away from the connector 114 (e.g., from a base 140 of the connector 114). The connector and/or back support can be positioned to meet various desired configurations. As shown in FIG. 9, the movable platform 120 can include one or more indentations. For example, two indentations can be included (e.g., configured to be positioned on either side of the connector). In some embodiments, the indentations comprise the speaker/microphone ports 118 discussed herein. Or the speaker/microphone ports 118 comprise the indentations. In some embodiments, the indentations can be sized to facilitate the removal of the portable electronic device from the dock. For example, the one or more indentations can have a depth that is configured to enable a user to place a finger under the bottom of the portable electronic device (or protective case).

As illustrated in FIG. 9, a body of the dock 112 can have indentations, openings, or cutouts 142 to complement the speaker/microphone ports 118. The cutouts 142 can extend into and/or be formed in the body of the dock 112 (e.g., toward the front panel 130 or perpendicular to the engagement-direction arrow 134) to extend functionally and physically extend the openings formed by the speaker/microphone ports 118 to provide a relatively larger effective area for directing sound as discussed herein. The cutouts 142 can be formed in the body of the dock 112 along the direction of travel of the movable platform 120 as discussed herein (e.g., along the engagement-direction arrow 134) to provide the relatively larger effective area as the movable platform 120 moves when the portable device 102 is engaged with the dock 112.

The movable platform 120 can include a rear portion 142 that can be flat or can be contoured to correspond to a bottom shape of the portable electronic device 102 (or protective case 104). In some embodiments, the indentations 118 do not extend into the rear portion. In some cases, the bottom of the portable electronic device 102 can be supported primarily by the rear portion 142 of the movable platform (e.g., that does not include the indentations). In some embodiments, a portion of the front of the portable electronic device 102 (or case 104 used therewith) can extend over the indentations 118, or a user can move the device forward so that it is positioned over the indentations for removal of the portable device 102 from the dock station 112.

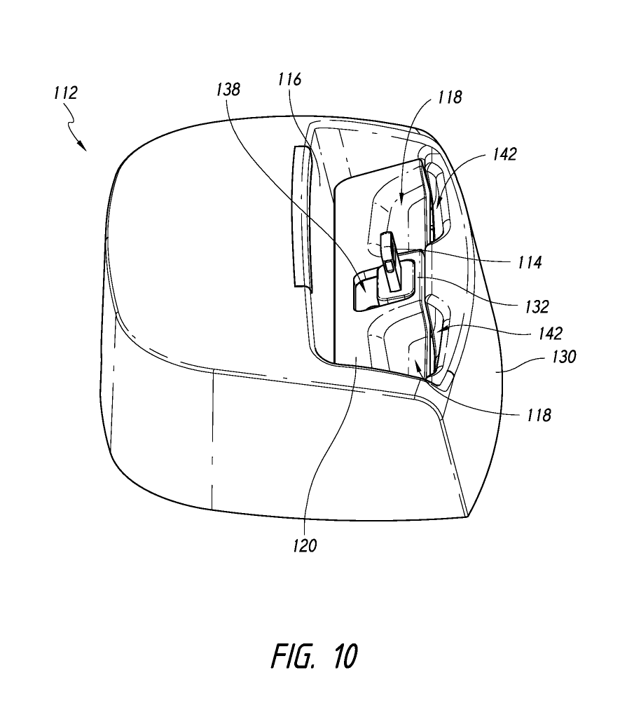

FIG. 10 is a side and top view of an embodiment of a dock station 112. In some embodiments, the connector 114 of the dock 112 can freely move (e.g., pivot or tilt) to accommodate mating with a connection port 108 on a portable electronic device 102. The connector 114 can remain substantially in the same position as when the portable device 102 was disengaged from the dock. In some embodiments, as illustrated in FIG. 10, the connector 114 can return to a forward position (e.g., toward the front panel 130) when neutral (e.g., not engaged with the portable device 102). Returning to the forward position as illustrated in FIG. 10 can facilitate reengagement of the portable device 102 with the dock 112. For example, the connector 114 is pointed or extending more to accommodate a natural reengagement motion of the portable device 102, and the connector 114 does not have to be moved or further spaced away from the back support 116 in order to reengage the portable device 102 (e.g., the back support 116 interfering with downward motion of the portable device 102 toward the connector 114 to engage the connector 114).

In some embodiments, the dock 112 can include a biasing element (e.g., a spring) that is configured to bias the connector 114 toward the forward position. For example, a coil spring can be disposed between the back side of the connector 114 and a portion (e.g., body) of the base 112 such that the coil spring is compressed when the connector 114 moves rearward. Those of skill in the art would understand, based on the disclosure herein, that many alternative biasing elements can be used to bias the connector 114 toward the forward position. For example, a coil spring or cantilever spring can be coupled to the bottom of the connector 114 (e.g., base 140 of the connector 114) and can be angled forward such that the resting position of the spring angles the connector 114 forward. Moving the connector 114 rearward can cause the spring to deform which can produce a restoring force that urges the connector 114 forward.

FIG. 11 is a side, top, and perspective view of embodiments of some internal components of an embodiment of a dock station 112. As illustrated in FIG. 11, the dock 112 can have a base or board 144 that supports internal components of the dock. The dock 112 can have plate supports 146 for supporting a retaining plate 148. The retaining plate 148 can fix and secure the height (vertical position) of the connector 114. The connector 114 can have an overmold 140 (e.g., base 140 of the connector 114) that at least partially forms the body of the connector 114. The overmold 140 can provide and/or secure a connection 114 between the connector 114 and a cable 122 for connecting to, for example, a personal computer.

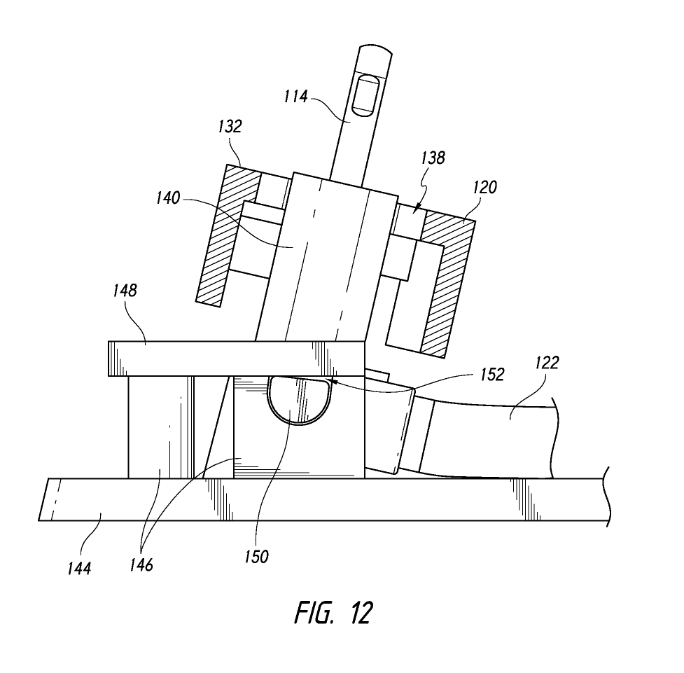

The overmold 140 can have flanges 150 that engage the plate supports 146. The flanges 150 can engage or mate with recesses, openings, and/or channels 152 of the plate supports 146. The flanges 150 and recesses 152 can be shaped to allow tilting or pivoting of the connector 114 as discussed herein. In some embodiments, the flanges 150 and/or the recesses 152 can be shaped to restrict tilting or pivoting of the connector 114 to a specified range of degrees as discussed herein. For example, the flanges 150 can have stops that prevent the connector 114 from tilting beyond a desired range by abutting features of the recesses 152, plate supports 146, retaining plate 148, board 144, and/or any other feature of the dock 112. As shown in FIG. 12, the flanges 150 can have a non-circular shape (e.g., semi-circular shape having a flat side for abutment as discussed herein) such that the flanges 150 can fit into the recesses 152 with a restricted range of rotation. The non-circular shape of the flanges 150 can be configured to permit the connector 114 to pivot across a range of motion. The non-circular shape of the flange 150 can abut an edge or side of the recess 152 to impede further rotation past or past the edge or side. As illustrated in FIG. 12, the edge or side of the recess 152 can be formed by the retaining plate 148. Any other suitable shape can be used to provide a limited range of motion to the connector 114 as discussed herein.

FIG. 12 is a side view of embodiments of some internal components of an embodiment of a dock station 112. As illustrated in FIG. 12, the dock 112 can have a movable platform 120 substantially at, about, near, and/or surrounding the connector 114, including an overmold 140 of the connector 114. When not engaged with a portable device 102 or engaged with a portable electronic device 102 without a protection case 104, the movable platform 120 can be substantially level with a top of the overmold 140 such that just the connector 114 (and not the overmold 140) protrudes beyond the level of the movable platform 120 or side of the movable platform 120 facing or abutting the portable device 102. In some embodiments, the level of the top of the overmold 140 can be a max height for the movable platform 120. In some embodiments, the overmold 140 can limit the travel of the connector 114 into the connection port 108. With the movable platform 120 at or substantially level with the top of the overmold 114 (e.g., top surfaces facing or abutting the portable device 102 substantially or relatively flush with each other), the movable platform 120 can support the portable device 102 without a protective case 104 and/or with a relatively thin protective case 104.

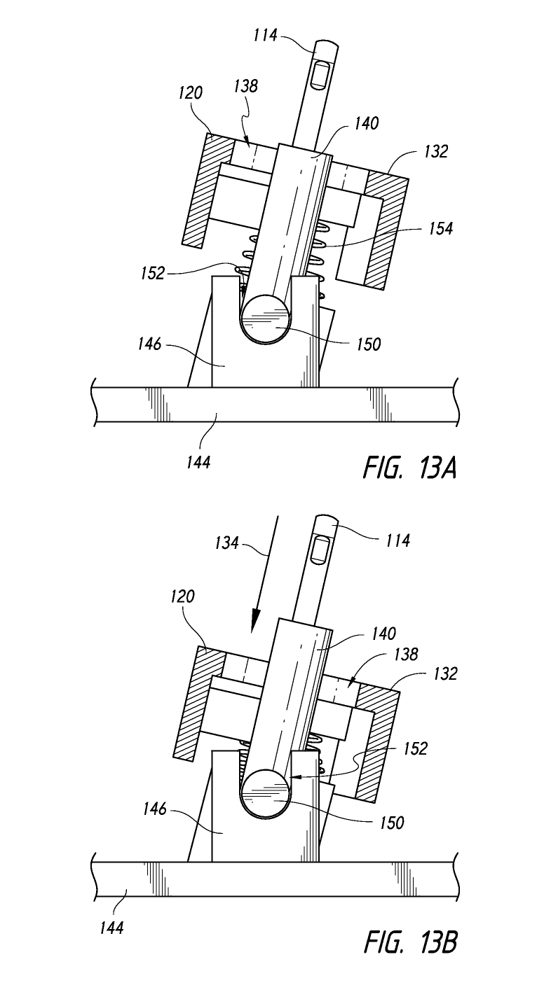

FIGS. 13A and 13B are side views of showing positions of an embodiment of a movable platform 120. The movable platform 120 can be supported by at least one biasing element 154 (e.g., a spring), which can bias the movable platform 120 to the raised or elevated position (e.g., FIG. 13A). The movable platform 120 can have any variable vertical position to accommodate various thicknesses of protective cases 104. FIGS. 13A and 13B illustrate that to accommodate various thicknesses of protective cases 104 while allowing the connector 114 to engage the connection port 108 of the portable electronic device 102, the movable platform 120 moves generally vertically and/or along engagement-direction arrow 134 while the connector 114, overmold 140, and/or other features of the dock 112 do not move generally vertically (e.g., remain stationary) relative to the dock 112 and/or board 144. The connector 114, overmold 140, and/or other features can remain in the same horizontal plane (e.g., substantially perpendicular to engagement-direction arrow 134) while the movable platform 120 moves generally vertically and/or along engagement-direction arrow 134 (e.g., to accommodate a protective case 104 on a portable electronic device 102). Stated differently, the movable platform 120 can move along a direction or path substantially parallel to a longitudinal or central axis (or side) of the connector 114 and/or overmold 140. With the movable platform 120 moving generally vertically to accommodate various thicknesses of protective cases 104, the connector 114 is permitted to substantially fully engage with the connection port 108 of the portable device 102 while the movable platform 104 provides support to the portable device 102.

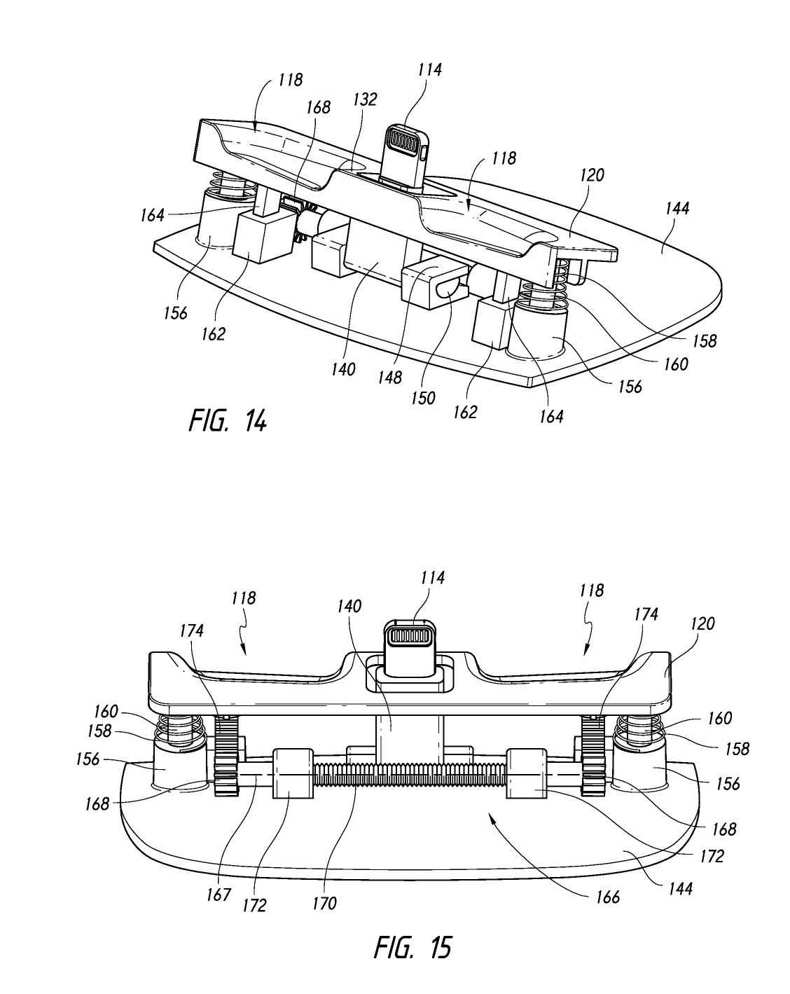

FIG. 14 is a side, top, and perspective view of embodiments of some internal components of an embodiment of a dock station 112. The dock 112 can have a board 144 connected to and/or forming a part of the dock 112 to provide support for various components of the dock 112. The board 144 can have platform supports 156. The platform supports 156 can have at least one biasing element (e.g., spring) 158 resting against the platform supports 156. The platform supports 156 can have spring guides or poles 160 to position, for example, coil springs 158 relative to the platform supports 156 and the movable platform 120. The springs 158 can bias the movable platform 120 to rise generally vertically as discussed herein when neutral or not pressed down by, for example, a protective case 104 of a portable electronic device 102. The spring poles 160 can provide support and/or restrict the vertical travel of the movable platform 120 within a desired range or path.

In some embodiments, the board 144 can have travel supports 162. The travel supports 162 can have travel guides 164 that provide support and/or restrict the generally vertical travel of the movable platform (e.g., along engagement-direction 134 or along a longitudinal axis of connector 114 and/or overmold 140 as discussed herein) to within a desired range or path. The travel guides 162 can restrict or inhibit movement of the movable platform 120 in the generally horizontal direction (e.g., acting as guides or tracks directing a path and/or length of path for the movable platform while restricting or inhibiting movement generally perpendicular to the engagement direction 134 or movement generally perpendicular to a longitudinal axis of the connector 114 and/or overmold 140). The platform supports 156, springs or other biasing elements 158, spring poles 160, travel supports 162, travel guides 164, and/or retaining plate 148 can be shaped, positioned, and/or mate with the movable platform 120 to restrict or inhibit travel of the movable platform 120 within a desired range or path as discussed herein. For example, in some embodiments, one or more protrusions can extend (e.g., generally downward) from the movable platform 120 and can be slidably received into one or more slots or tracks that are formed on the base or board 144 of the dock 120. In some embodiments, one or more slots or tracks on the movable platform 120 can slidably receive one or more protrusions that extend (e.g., generally upwardly) from the base or board 144 of the dock 112. The one or more protrusions can slide along the one or more slots or tracks as the movable platform 120 moves between positions, and the engagement of the one more protrusions with the one or more slots or tracks can restrict the range of motion of the movable platform 120 (e.g., to a substantially linear path of motion along engagement-direction 134 as discussed herein).

FIG. 15 is a back and top view of embodiments of some internal components of an embodiment of a dock station 112. The dock 112 can have a board 144, platform supports 156, springs or other biasing elements 158, spring poles 160, travel supports 162, travel guides 164, retaining plate 148, and/or the like as discussed herein, and in particular in reference to FIG. 14. As illustrated in FIG. 15, the dock 112 can have a leveling mechanism 166 configured to maintain the movable platform 120 substantially level as the movable platform 120 moves between different positions discussed herein. The leveling mechanism 166 can include a leveling axle 167 that is positioned substantially horizontally relative to the board 144 and/or movable platform 120. The leveling axle 167 can extend between two gears 168 and extending through an axle spring 170 illustrated in FIG. 15. An embodiment of the leveling axle 167 is illustrated in FIG. 15 with dashed lines as being positioned between gears 168 as well as within an axle spring 170 and bearing or coupling member 172.

The base or board 144 can engage the leveling axle 167 via bearings or coupling members 172. The bearings or coupling members 172 are supports connected to the board 144. The bearings or coupling members 172 can have openings sized to allow the leveling axle 167 to fit therethrough. In some embodiments, the bearings or coupling members 168 can include ball bearings and/or the like for facilitating rotation of the leveling axle 167 about its axis.

The leveling axle 167 can have at least two gears 168 that are spaced apart from each other (e.g., the gears 168 can be positioned at or near the ends of the leveling axle 167). The gears can engage tracks 174 that have features (e.g., teeth) configured to engage the gears 168. As the movable platform 120 moves between positions, the at least two gears 168 can rotate together or simultaneously along the respective tracks 174 such that the movable platform is maintained substantially level. Those of skill in the art will understand, based on the disclosure herein, that many configurations are possible. The tracks 164 can be fixed to the travel guides 164. The travel guides 164 can be fixed to the base or board 144 and/or the travel supports 162. In some embodiments, the tracks 174 can be fixed to the base or board 144 of the dock 112, the rotating gears 168 can be coupled to the movable platform 120. The tracks 174 (e.g., on at least one travel guide 164) can be fixed to the movable platform 120, and in some embodiments, the two or more gears 168 can be coupled to the base or board 144 of the dock 112.

With the gears 168 fixed to the same axle and the tracks 174 fixed to the movable platform 120, tilting to one side the dock 112 of the movable platform 120 (e.g., where the movable platform 120 is not level relative to a resting surface for the dock 112 or substantially not perpendicular to the engagement-direction arrow 134) can be prevented, inhibited, or impeded. For example, as one side of the movable platform 120 is pressed down, the leveling axle 167 and gears 168 rotate in unison to cause the other side of the movable platform 120 to move down via engagement between the gears 168 fixed to the leveling axle 167 and the tracks 174 attached to the movable platform 120 and moving in unison. With both the movable platform 120 and the connector 114 inhibited from tilting left or right (e.g., side to side or substantially perpendicular to pivoting-direction arrow 136) as discussed in certain embodiments herein, the movable platform 120 can provide even support along a bottom of the portable electronic device 102 and help prevent tilting left or right (e.g., side to side) of the electronic device 102 relative to the dock 112 (including the movable platform 120 and/or connector 114). The length, dimensions, and/or area of the support along the bottom of portable device 102 can vary depending the shape and size of the movable platform 120. For example, the movable platform 120 can have a length that provides at least about 10 mm, or less, of support to about 100 mm, or more, of support, or at least 40 millimeters of support, along the bottom of the portable device 102. Further, the portable device 102 can be disengaged from the connector 114 by tilting the portable device 102 to one side (left or right) while certain features of the dock 112 remain relatively level as discussed herein.

In some embodiments, the dock 112 can have an axle spring 170 that biases (e.g., via the gears 168 and tracks 174) the movable platform 120 upward (e.g., toward the top of the overmold 140 as discussed herein). For example, the axle spring 170 can bias the gears 168 to rotate in a direction that moves the tracks 174 vertically upwards (e.g., opposite direction of the engagement-direction 134), which moves the movable platform 174 upwards (e.g., rise to be level to a top surfaces of the overmold 140) via fixed engagement with the tracks 174. With the movable platform 120 biased upward, the movable platform 120 can facilitate disengagement of the portable electronic device 102 from the connector 114. In some embodiments, the springs (e.g., springs 158 or axle spring 170) discussed herein can be adjusted to achieve a desired level of support along the bottom of the portable device 102 (and/or protective case 104).

The connector 114 can be shaped and sized to provide a desired level of physical engagement with the connection port 108 of the portable device 102. The physical engagement between the connector 114 and connection port 108 can be measured in a pull force required to disengage the portable device 102 from the connector 114. In some embodiments, the pull force can range from about 0.2 kg, or less, to about 3 kg, or more, pull force (kgf). For example, the connector 114 can provide about a 0.65 kg pull force to disengage from the portable electronic device 102. The pull force (e.g., about 0.65 kg) can be a sufficient force to keep the portable electronic device 102 engaged with the connector 114 while depressing the movable platform 120 that is biased upward by, for example, springs as discussed herein (e.g., the portable device 102 is engaged with a protective case 102 and the movable platform 120 is depressed by the protective case 104 while the movable platform 120 is biased upward against a bottom of the portable device 102).

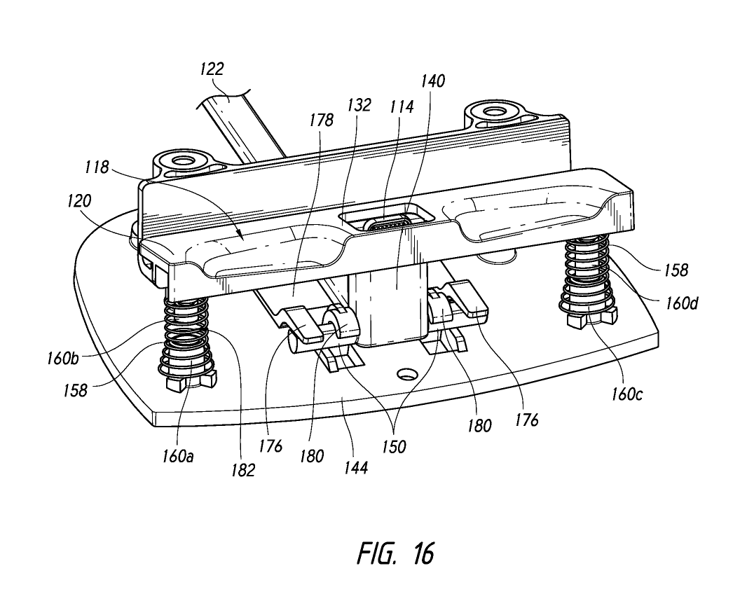

FIG. 16 is a front perspective view of some internal components of an embodiment of a dock station 112. As discussed herein, a biasing element 176 can bias the connector 114 toward a forward position. As illustrated in FIG. 16, the connector 114 can include one or more cams 150 (e.g., flanges 150 as discussed herein). For example, the cams 150 can be one or more flanges extending from an overmold portion 140 of the connector 114 (e.g., extending from one or more locations at or near the base of the connector 114).

One or more biasing elements 176 can be positioned to engage the one or more cams 150 when the connector 114 is rotated in the rearward direction. Rearward movement (e.g., pivoting) of the connector 114 can cause the cams 150 to rotate such that a wide portion of the cam 150 displaces the biasing element 176 (which can be a spring, such as a leaf spring, cantilever spring, coil spring, etc.). The cams 150 can have an oval shape such that in, for example, rearward positions of the connector, the minor or relatively shorter dimension of a cross-section of oval shape of the cams 150 is substantially parallel to the engagement-direction arrow 134. When the cams 150 are rotated via the connector 114 being rotated to, for example, the rearward position, the longitudinal or relatively longer dimension of the cross-section of the oval shape of the cams 150 moves to be relatively more vertical, deflecting the biasing elements 176 to create the bias force back to the forward position of the connector 114 as discussed herein. In some embodiments, the cams 150 and biasing elements 176 can be arranged such that the connector 114 is biased toward the rearward position and moving the connector to the forward position displaces the biasing elements 176 to create a biasing/restoring force on the connector 114 toward the rearward position.

Displacement of the biasing element 176 by the wide portion of the cam 150 can produce a restoring force that urges the connector 114 forward (e.g., by rotating the cam 150). The biasing element 176 can include one or more arms that extend over the cams 150, and the arms (e.g., reference character 176 points to the arms in FIG. 16) can have an unrestrained end portion can be deflected by the cams 150 upon rearward movement of the connector 114, as discussed herein. In some embodiments, at least two arms extend over at least two cams 150. The arms 176 can be coupled to the base 144 of the dock station 112. For example, two or more arms 176 can extend from a single coupling element 178 (e.g., a plate) that is coupled to the base 144 and/or retaining plate 148 (e.g., by an adhesive, screws, rivets, snap fit features, friction fit features, or other suitable attachment mechanisms).

As illustrated in FIG. 16, the base 144 can have collars 180 that extend or project over the cams 150. In some embodiments, the collars 180 can extend over the cams 150 and be connected to the retaining plate 148 discussed herein. The collars 180 can overlap, envelope, or extend over the cams 150 to rotatably engage the cams 150 to allow rotation or pivoting of the connector 114 as discussed herein while substantially fixing the connector 114 in other directions (e.g., directions other than pivoting-direction arrow 136 such as in the direction of the engagement-direction arrow 134).

With continued reference to FIG. 16, the spring poles 160 can be formed from two portions: a bottom spring pole portion 160a and a top spring pole portion 160b. The bottom spring pole portion 160a and the top spring pole portion 160b can be considered an embodiment of a range limiting mechanism or range mechanism. The bottom spring pole portion 160a can be attached to the base 144. The bottom spring portion 160a can be a bottom projection, protrusion, and/or the like extending from and/or formed with the base 144. The top spring pole portion 160b can be attached to the movable platform 120.

The top spring pole portion 160b can be a top projection, protrusion, and/or the like extending from and/or formed with movable platform 120. The bottom spring pole portion 160a and the top spring pole portion 160b can be sized and shaped to form a space or gap 182 between the bottom spring pole portion 160a and the top spring pole portion 160b when the movable platform 120 is in the upward/elevated position as discussed herein. When the movable platform 120 is moved or depressed downward along engagement-direction arrow 134 as discussed herein, the top spring pole portion 160b moves with the movable platform 120 toward the bottom spring pole portion 160a fixed to base 144 such that the space or gap 182 becomes smaller. When an end or edge of the top spring pole portion 160b (e.g., the end facing the bottom spring pole portion 160a) abuts or comes against an end or edge of the bottom spring guide portion 160 (e.g., the end facing the top spring pole portion 160b), further movement of the movable platform 120 along engagement-direction arrow 134 is prevented or inhibited. The relative longitudinal lengths/heights (e.g., along engagement-direction arrow 134) of the bottom spring pole portion 160a and the top spring pole portion 160b, and respectively, the length or height (e.g., along engagement-direction arrow 134) of the gap 182, can be varied to provide a desired travel range of motion to the movable platform 120 (e.g., along engagement-direction arrow 134).

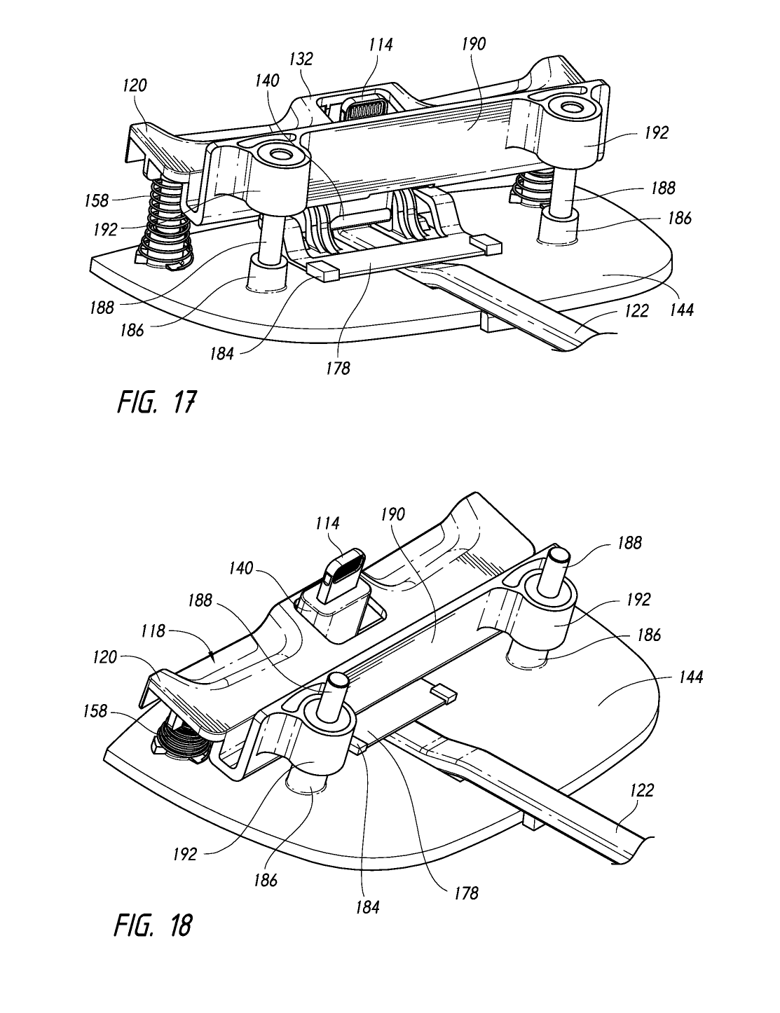

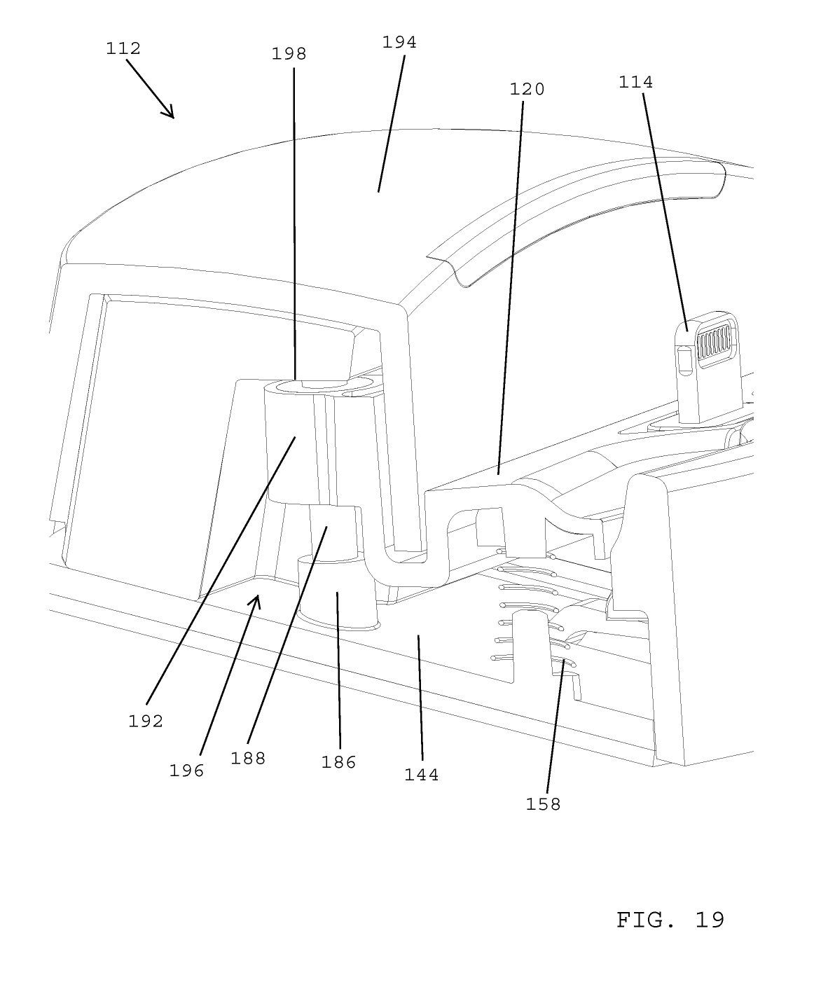

FIGS. 17 and 18 are rear perspective views of some internal components of the embodiment of a dock station shown in FIG. 16. In FIG. 17, the movable platform 120 is in a raised/elevated position, and in FIG. 18, the movable platform 120 is in a lowered/depressed position. As illustrated in FIGS. 16 and 17, in some embodiments, the raised/elevated (e.g., neutral) position of the movable platform 120 can be elevated such that the upper surface or side 132 of the movable platform 120 facing the portable device 102 is flush with an upper end or surface of the connector 114 (e.g., the end of the connector 114 facing toward the portable device 102). Accordingly, the movable platform 120 in the raised position can substantially envelope or hide the connector 114 within the opening 138 of the movable platform 138. Stated differently, the opening 138 can contain or substantially envelope/surround the connector 114 within its boundaries when the movable platform 120 is in the raised position. Accordingly, when the movable platform 120 is in the raised position (e.g., a portable device 102 is not engaged with the dock 112), the connector 114 can be substantially protected from the external environment to, for example, prevent, inhibit, or minimize damage to or dust accumulation on the connector 114.

As discussed herein, the dock 112 can be configured to maintain the movable platform 120 substantially level as it moves between the raised position and the lowered position. Although the dock station can permit minor deviations from a perfectly level orientation for the movable platform 120, the dock station 112 can be configured to maintain the movable platform 120 substantially level such that the portable electronic device 102 (e.g., a mobile phone) can be reliably supported by the movable platform 120. For example, the movable platform 120 can be maintained within about 15 degrees, within about 10 degrees, within about 5 degrees, within about 2 degrees, or within about 1 degree of a level horizontal position.

As illustrated in FIGS. 17 and 18, the coupling element 178 with the two or more arms 176 can be connected to the base 144. The base 144 can have notches, slots, grooves, tracks, and/or the like 184 to engage the retaining plate 178 at a desired and/or predetermined position to position the arms 176 in a desired position relative to the cams 150 as discussed herein (e.g., to deflect upon movement of the cams 150 and provide a biasing/resistive force to a resting position of the arms 176 as determined by the position of the retaining plate 178).

With continued reference to FIGS. 17 and 18, the base 144 can support or be connected to guide supports 186. The guide supports 186 can have poles, shafts, or bearing guides 188 connected to the guide supports 186. The guide supports 186 can orient the bearing guides 188 in a desired position relative to, for example, the base 144. The guide supports 186 can orient or position the bearing guides 188 to be substantially vertical and/or along engagement-direction arrow 134. The bearing guides 188 can be metal rods or poles made of any suitable material to provide desired durability and guidance to the movable platform 120 as discussed herein.

As further illustrated in FIGS. 17 and 18, the movable platform 120 can have a back frame or back panel 190 connected to and/or forming a part of the movable platform (e.g., forming the back support 116). The back panel 190 can have sleeves or guide collars 192 formed with and/or extending from the back panel 190. The guide collars 192 can be substantially round or any other suitable shape to envelope, surround, engage, and/or mate with the bearing guides 188. The guide collars 192 can engage the bearing guides 188 to slide or move along substantially the longitudinal or central axis of the bearing guides 188 (e.g., vertically and/or substantially along the engagement-direction arrow 134) as the movable platform 120 is moved from the raised and lowered positions shown in FIGS. 17 and 18, respectively. The guide collars 192 can each have any suitable bearings, sleeves, or guides to engage the bearing guides 188 to provide sufficient guidance for the movable platform 120 along the engagement-direction 134 (e.g., minimize tilting or non-level movement of the movable platform 120 as discussed herein), while minimizing friction between the bearing guides 188 and the guide collars 192 (e.g., for the movable platform 120 to move between the raised and lowered positions with minimal forces required).

Accordingly, as the movable platform 120 is moved or depressed vertically and/or along engagement-direction arrow 134, the guide collars 192 move along the sides or the longitudinal/central axis of the bearing guides 188 to guide the movable platform 120 along a desired or predetermined path as discussed herein. As illustrated in FIG. 18, the guide collars 192 can come against, contact, or abut the guide supports 186 to limit the travel range of the movable platform 120 past or beyond the lowered position. In some embodiments, any feature of the movable platform 120 can come against, contact, or abut any feature of, for example, the base 144 to limit the travel range of the movable platform 120 past or beyond the lowered position.

As the movable platform 120 is moved into the lowered position as illustrated in FIG. 18, the springs 158 (or any other suitable biasing element) are compressed. Upon release of the force depressing or lowering the movable platform 120, the springs 158 decompress (return to neutral position or form) and push on the movable platform 120 or any other part connected movable platform 120 to move up the movable platform 120 as the guide collars 192 move along the bearing guides 188. The movable platform 120 then can return to its resting/neutral or raised position as illustrated in FIG. 17. The bearing guides 188 and/or guide collars 192 can have features that engage, mate, and/or interlock with each other when the moveable platform is in the raised position to limit upward travel (e.g., travel distance) of the movable platform 120 past or beyond the raised position. In some embodiments, any feature of the movable platform 120 can engage, mate, and/or interlock with any feature of, for example, the base 144 to limit the travel range of the movable platform 120 past or beyond the raised position.

FIG. 19 illustrates a cross-sectional side, top, and perspective of an embodiment of a dock 112. The dock 112 can have a main housing 194 encasing or housing the internal components of the dock 112 discussed herein. The main housing 194 can have a cavity or opening 196 that encases, surrounds, or houses the bearing guides 188 and/or guide collars 192 while allowing the guide collars 192 to move over the bearing guides 188 as discussed herein. As illustrated in FIG. 19, the main housing 194 and/or cavity 196 can have a wall 198 positioned in a predetermined position for the guide collars 192 to come against, contact, or abut the wall 198 in, for example, the raised position of the movable platform 120. The predetermined position of the wall 198 can provide the travel distance of the movable platform 120 as discussed herein by mitigating, inhibiting, or preventing movement of the movable platform 120 beyond or past the raised position to act a range limiting mechanism or range mechanism. The position of the wall 198 can be used to complement or substitute any other range mechanism discussed herein.

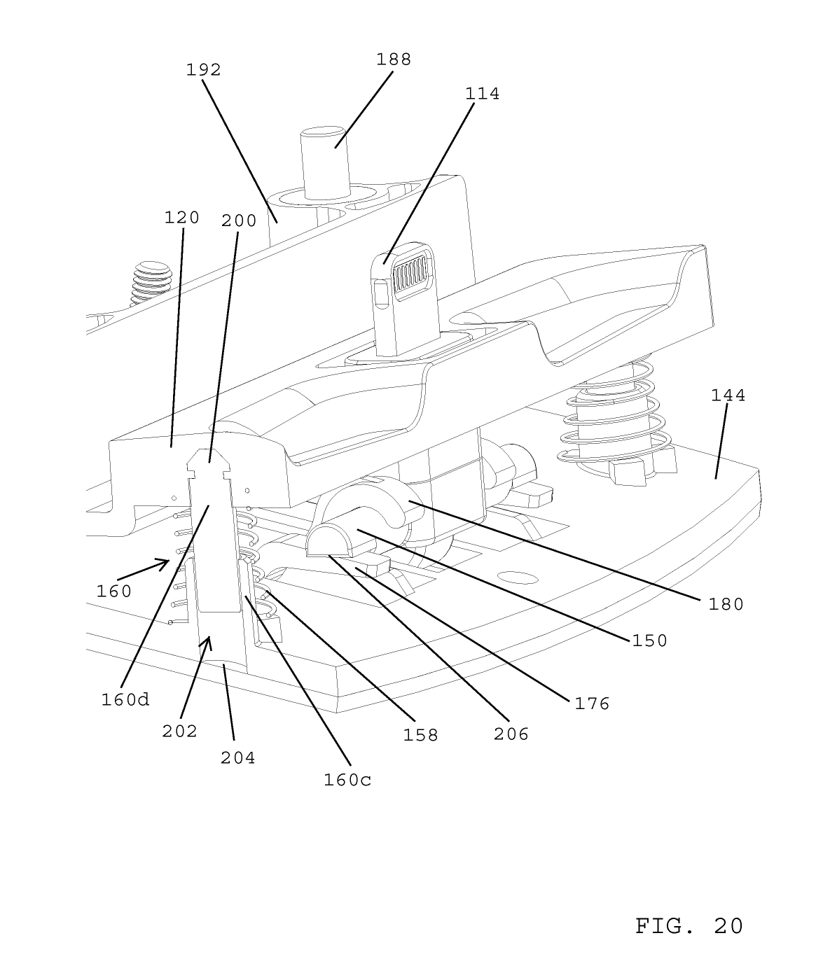

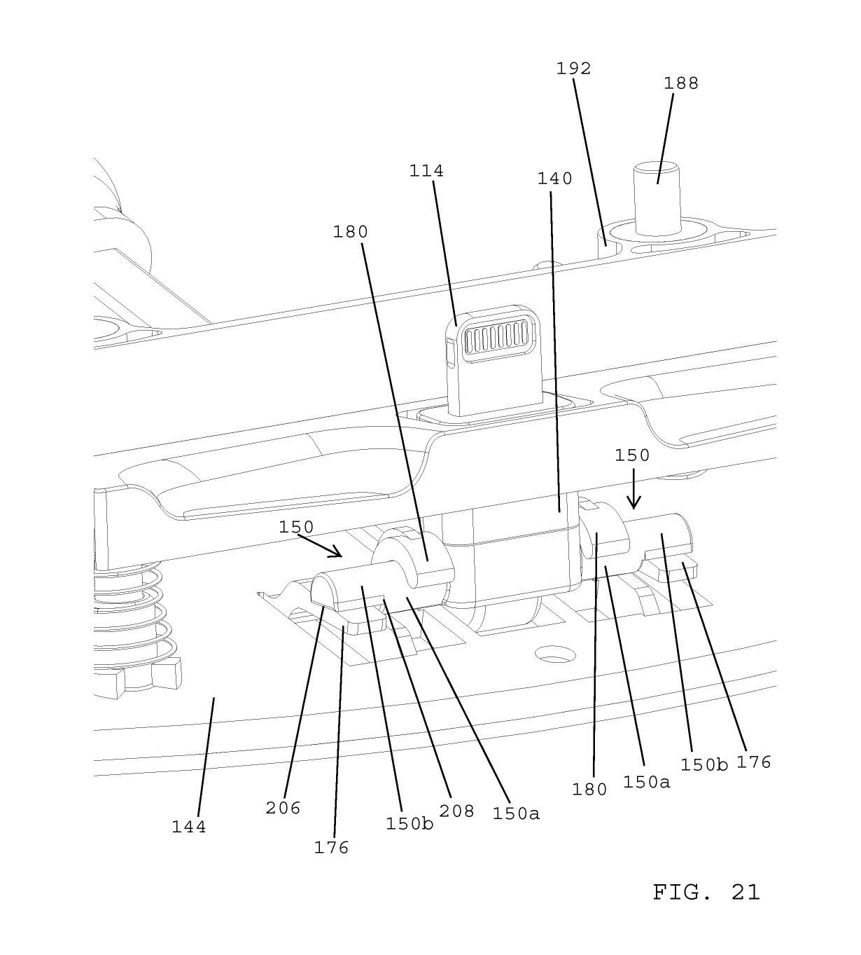

FIG. 20 illustrates a cross-sectional side, top, and perspective view of an embodiment of some internal components of a dock 112. The spring poles 160 can be formed from two portions: a bottom spring pole portion 160c and a top spring pole portion 160d (see also FIG. 16). The bottom spring pole portion 160c and the top spring pole portion 160d can be considered an embodiment of a range limiting mechanism or range mechanism. The bottom spring pole portion 160c can be attached or connected to the base 144. The bottom spring portion 160c can be a bottom projection, protrusion, and/or the like extending from and/or formed with the base 144.

The top spring pole portion 160d can be attached or connected to the movable platform 120. As illustrated in FIG. 20, the top spring pole portion 160c can have a rivet-like head 200 with features that are configured to engage corresponding features formed in the movable platform 120 to form an interlocking connection. Any other suitable connection discussed herein between the top spring pole portion 160d and the movable platform 120 can be used.

With continued reference to FIG. 20, the bottom spring pole portion 160c can have a channel, opening, or cavity 202 sized to slidably engage the top spring pole portion 160d. For example, the channel 202 can function as the guide collars 192 (e.g., sleeves) as discussed herein. As the movable platform 120 moves between the raised position and the lower position as discussed herein, the top spring pole portion 160d can move or slide along longitudinal or central axis of the channel 202 (e.g., along engagement-direction arrow 134) to guide the movable platform 120 along a desired travel path between the raised and lowered positions. For example, the top spring pole portion 160d can function as the bearing guides 188 (e.g., shafts) as discussed herein.

The travel distance of the moveable platform 120 can be limited by a stopping surface 204. The top spring pole portion 160d can come against, contact, or abut the stopping surface 204 to limit movement of the movable platform 120 beyond the lowered position. The position stopping surface 204 and/or length of the top spring pole portion 160d can be used to complement or substitute any other range mechanism discussed herein. The slideable arrangement of the top and bottom spring pole portions 160c, 160d can be be used in lieu of or complimentary to other leveling mechanisms discussed herein, such as for example, in reference to bearing guides 188 and/or guide collars 192, and can function substantially similarly.

With continued reference to FIG. 20, as discussed herein, the cam 150 can have a non-circular shape. The cam 150 can have a semi-circular shape with a flat side 206. The flat side 206 of the cam 150 can be positioned to generally face (e.g., be substantially flush with) an arm 176 of a biasing element, such as for example, a leaf spring or cantilever spring as illustrated in FIG. 20. When the connector 114 is pivoted as discussed herein, the flat side 206 rotates relative to the arm 176 to displace the arm 176 from a neutral or resting position against the flat side 206 (e.g., by no longer being flush and a corner of the flat side 206 displacing the arm 176). Upon release of the force pivoting the connector 114, the flat side 206 is moved back to generally face (e.g., be flush with) the arm 176 having a correspondingly flat side.

FIG. 21 illustrates a side, top, and perspective view of an embodiment of some internal components of a dock 112. As illustrated in FIG. 20, the cam 150 can be formed from two portions: a circular cam portion 150a and a non-circular cam portion 150b. The circular cam portion 150a can be generally or substantially round or circular to engage the collars 180 that are correspondingly round or circular to allow for a smooth rotation or pivoting motion of the connector 114 as discussed herein. The circular cam portion 150a allows for continuous engagement of the collars 180 as the connector 114 is pivoted while mitigating, inhibiting, or preventing movement of the connector 114 that is not substantially along the pivoting-direction arrow 136 as discussed herein. The non-circular cam portion 150b can have a flat side 206 that engages the arm 176 as discussed herein. The transition 208 between the circular cam portion 150a and the non-circular cam portion 150b can further engage the arms 176 to mitigate, inhibit, or preventing side to side movement (e.g., perpendicular to the pivoting-direction 136) of the connector 114.

While the flat side 206 is illustrated in FIG. 21 as facing the base 144 (e.g., downward), the flat side 206 can face toward (e.g., upward) the movable platform 120 as illustrated in FIGS. 16 to 18. The arms 176 can correspondingly be positioned to be flush with the flat side 206 depending on which direction the flat sides 206 faces.

Those of skill in the art will understand based on the present disclosure that various types of leveling mechanisms can be used to maintain the movable platform substantially level as it moves between the raised and lowered positions. In some embodiments, two or more shafts can extend generally upward (e.g., from the base of the dock), and two or more corresponding sleeves can be coupled to the movable platform. As the movable platform moves between the raised position and the lowered position, the two or more sleeves can slide along the two or more respective shafts. The shafts and sleeves can operate generally as a piston, in some cases. The two or more sleeves and corresponding shafts can maintain the movable platform substantially level as it moves between the raised position and the lowered position. For example, if the movable platform starts to tilt past a substantially level orientation, the sleeves can become misaligned with the corresponding shafts, which can cause them to bind or jam, thereby preventing the movable platform from tilting further from the substantially level orientation. In some embodiments, two shafts and two corresponding sleeves can be used. In some embodiments, four shafts and four corresponding sleeves can be used. For example, in some embodiments, shafts and corresponding sleeves can be disposed inside the coil springs that are used to bias the movable platform toward the raised position.

In some embodiments, a single shaft can be slidably received by a single sleeve to maintain the movable platform at a substantially level orientation. For example, the shaft can have an outer diameter that is close the size of the inner diameter of the sleeve, such that the play between the sleeve and the shaft is sufficiently minimized to maintain the movable platform at the substantially level orientation. For example, depending on the dimensional clearance/tolerance between the sleeves and shafts (e.g., the inner diameter of the sleeve relative to the outer diameter of the shaft for a cylindrical opening formed by the sleeve to fit over a cylindrical rod formed by the shaft), the shaft can prevent or impede tilting of the sleeve, and thereby, prevent or impede tilting of the movable platform via the sleeve being fixed to the movable platform. The smaller the dimensional clearance between the sleeve and shaft, the less the sleeve tilts relative to the fixed shaft, and the less the movable platform tilts relative to the base. In some embodiments, the sleeve can have a length that is long enough to minimize play between the shaft and sleeve to maintain the movable platform at the substantially level orientation. The longer the sleeve, the greater the dimensional clearance that can be tolerated between the sleeve and shaft while restricting tilting of the movable platform with the ranges of movement discussed herein. In some embodiments, the dimensional clearance/tolerance as discussed above applies similarly to two or more assemblies of sleeves and shafts. Those of skill in the art will understand, based on this disclosure, that a substantially level movable platform can be achieved by a shorter sleeve if the gap (e.g., dimensional clearance) between the sleeve and the shaft is sufficiently small, and that a substantially level movable platform can also be achieved by a shaft and sleeve with a larger gap if the length of the sleeve is sufficiently long to reduce the play between the shaft and the sleeve.

The foregoing description has set forth various embodiments of the systems and/or methods via the use of figures and/or examples. Insofar as such figures and/or examples contain one or more functions and/or operations, it will be understood by those within the art that each function and/or operation within figures or examples can be implemented individually and/or collectively. The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced embodiment recitation is intended, such an intent will be explicitly recited in the embodiment, and in the absence of such recitation no such intent is present. For example, as an aid to understanding, the disclosure may contain usage of the introductory phrases “at least one” and “one or more” to introduce embodiment recitations. However, the use of such phrases should not be construed to imply that the introduction of an embodiment recitation by the indefinite articles “a” or “an” limits any particular embodiment containing such introduced embodiment recitation to embodiments containing only one such recitation, even when the same embodiment includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, embodiments, or drawings, should be understood to contemplate the possibilities of including one of the terms, either of the terms, or both terms. For example, the phrase “A or B” will be understood to include the possibilities of “A” or “B” or “A and B.”

Although the present subject matter has been described herein in terms of certain embodiments, and certain exemplary methods, it is to be understood that the scope of the subject matter is not to be limited thereby. Instead, the Applicant intends that variations on the methods and materials disclosed herein which are apparent to those of skill in the art will fall within the scope of the disclosed subject matter.

1. A dock station for use with a portable electronic device, the dock station comprising:
a base;
a connector extending generally upward from the base, the connector configured to engage a connection port on a portable electronic device to provide an electrical connection between the dock station and the portable electronic device;
a movable platform that is movable relative to the connector, the movable platform movable between a raised position and a lowered position, and the movable platform configured to support a bottom of the portable electronic device; and
a biasing element that biases the movable platform toward the raised position.

2. (canceled)

3. The dock station of claim 1, wherein the connector is movable between a forward position and a rearward position.

4. The dock station of claim 3, further comprising a connector biasing element that biases the connector toward the forward position.

5. (canceled)

6. The dock station of claim 4, wherein the connector comprises one or more cams, and wherein rotation of the cam as the connector moves toward the rearward position causes the one or more cams to displace the connector biasing element to produce a force that urges the connector toward the forward position.

7-8. (canceled)

9. The dock station of claim 1, further comprising a leveling mechanism that maintains the movable platform substantially level as the movable platform moves between the raised position and the lowered position.

10-13. (canceled)

14. The dock station of claim 9, wherein the leveling mechanism comprises:
two or more shafts; and
two or more sleeves configured to slidably receive the respective two or more shafts;
wherein the engagement of the two or more shafts with the respective two or more sleeves is configured to maintain the movable platform substantially level as the movable platform moves between the raised position and the lowered position.

15. (canceled)

16. The dock station of claim 14, wherein the two or more shafts extend generally upward from the base, and wherein the two or more sleeves are coupled to the movable platform.

17. The dock station of claim 14, wherein the two or more shafts extend generally downward from the movable platform, and wherein the two or more sleeves are coupled to the base.

18. (canceled)

19. The dock station of claim 9, wherein the leveling mechanism comprises:
a shaft having an outer diameter;
a sleeve configured to slidably receive the shaft, the sleeve having a length and an inner diameter;
wherein the outer diameter of the shaft, the inner diameter of the sleeve, and the length of the sleeve are configured to maintain the movable platform substantially level as the movable platform moves between the raised position and the lowered position.

20. The dock station of claim 19, wherein the shaft extends generally upward from the base, and wherein the sleeve is coupled to the movable platform.

21-28. (canceled)

29. The dock station of claim 1, wherein the movable platform moves to the lowered position to accommodate a thickness of a protective case of the portable electronic device to allow the connector to engage the connection port of the portable electronic device.

30. A dock for use with a portable device, the dock comprising:
a base;
an electrical junction connected to the base, the electrical junction configured to engage a connection port on a portable device to provide an electrical connection between the dock and the portable device; and
a support surface that is movable relative to the base, the support surface movable between a first position and a second position, and the support surface configured to support a side of the portable device having the connection port.

31. The dock of claim 30, further comprising a biasing element that biases the support surface toward the first position.

32. The dock of claim 31, wherein the biasing element comprises a spring that pushes the support surface into the first position when the support surface is moved from the first position toward the second position such that the spring is compressed.

33. (canceled)

34. The dock of claim 30, wherein the first position is further away from the base relative to the second position.

35. The dock of claim 30, wherein the support surfaces comprises an opening through which the electrical junction connects with the portable device.

36-53. (canceled)

54. The dock of claim 30, further comprising a range mechanism providing a predetermined travel distance of the support surface between the first position and the second position.

55-60. (canceled)

61. A dock for use with a portable device, the dock comprising:
a connector configured to engage the portable device to form an electrical connection between the dock and the portable device; and
a support that is movable relative to the connector, the support movable between a first position and a second position, and the support configured to support the portable device.

62. The dock of claim 61, further comprising a base, the connector pivotally connected to the base and extending from the base toward the support.

63. The dock of claim 61, further comprising a biasing element, the biasing element configured to bias the support toward the first position, and wherein the support is moved toward the second position when the connector engages the portable device having a protective case disposed on the portable device proximate to a connection port of the portable device configured to engage the connector to form the electrical connection.
